(19) United States
(12) Patent Application Publication
(10) Pub. No.: US 2010/0078327 A1
(43) Pub. Date: Apr. 1, 2010

(54) Deionization apparatus, electrode module for the same and method for manufacturing the same

(75) Inventors: Hyong Soo Noh, Suwon-si (KR); Won Kyoung Lee, Suwon-si (KR); Jun Ho Ji, Namyangju-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/457,846

(22) Filed: Jun. 23, 2009

(30) Foreign Application Priority Data
Sep. 30, 2008 (KR) 2008-95748

(51) Int. Cl. B01D 61/46; B29C 65/02

(52) U.S. Cl. 204/633; 156/322

(57) ABSTRACT

In the deionization apparatus, among a pair of electrode modules to which a power is applied, only one electrode module includes an electrode capable of adsorbing ions to impart an ion-adsorption capability thereto and the other electrode module includes an electrode having no ion-adsorption capability not to impart an ion-adsorption capability thereto, to remove only one of cations and anions, in order to improve production efficiency and reduce manufacturing costs.

### CROSS-REFERENCE TO RELATED APPLICATIONS

This application claims the benefit of Korean Patent Application No. 2008-0095748, filed on Sep. 30, 2008 in the Korean Intellectual Property Office, the disclosure of which is incorporated herein by reference.

### BACKGROUND

1. Field

The present invention relates to a deionization apparatus, and, more particularly, to a deionization apparatus to remove ions contained in a liquid using an electrochemical method, an electrode module for the same and a method for manufacturing the same.

2. Description of the Related Art

There are several methods for purifying water containing substances such as NaCI or heavy metals. Of these methods, a method for purifying water using an ion exchange resin is generally used. However, this method requires the use of acidic or basic solutions upon recycling resins and of a great amount of polymeric resins and chemicals to treat large volumes of water, thus disadvantageously having low economic efficiency.

In order to solve this disadvantage, a great deal of research has recently been conducted into a capacitive deionization (hereinafter, referred to as a “CDI”) apparatus.

A CDI technique is based on a simple principle that when a voltage is applied between two porous carbon electrodes, i.e., a positive electrode and a negative electrode, taking the form of a stack, cations and anions are electrically adsorbed on the positive electrode and the negative electrode, respectively, to remove ions contained in a fluid such as water. In addition, in such a technique, when ions are saturated on electrodes, they can be readily detached therefrom, thus enabling simple recycling of the electrodes by switching the polarity of the electrode, or ceasing power supply (also referred to as a “current source”). Like ion exchange resin methods or reverse osmosis for electrode recycling, the CDI technique eliminates the necessity of using any acidic or basic cleaning solution, thus being free of secondary chemical waste products. Furthermore, the CID technique is almost free of corrosion or contamination of electrodes, thus advantageously having a semi-permanent lifespan and relatively high energy efficiency and thus 10 to 20-fold energy savings, compared to other methods.

Such a CDI apparatus includes end plates provided in upper and lower terminals, a plurality of electrode modules constituting an intermediate layer, and materials such as bolts, nuts and seals to combine the electrode modules.

The electrodes of the electrode module are formed by bonding a carbon material, having a high specific surface of pores and the capability of adsorbing ions, onto a collector using a conductive material. A channel, enabling formation of a passage, is formed in a predetermined area of the collector and a carbon material is bonded onto one or both sides of the collector, to form an electrode.

A CDI apparatus is composed of a stack including a plurality of alternating electrode modules. In such a CDI stack, when a positive (+) electrode and a negative (−) electrode are connected to the power source of the electrodes and water is then injected into an inlet arranged in an upper or lower part, water moves in the form of a zigzag through the channel provided in each collector. While water passes through the positive and negative electrodes, anions contained in water are adsorbed on the carbon material of the positive electrode and cations contained therein are adsorbed on the carbon material of the negative electrode. After the ions are adsorbed to the electrodes, the electrodes are switched to each other, or a current is interrupted, thereby removing the ionic components adsorbed on the carbon material and thus simply recycling the electrode.

In a conventional CDI apparatus, both an electrode module to which the positive (+) electrode is applied, and an electrode module to which the negative (−) electrode is applied include an electrode having the capability to absorb ions. Accordingly, since both electrode modules have the deionization capability, both cations and anions contained in water are removed.

However, when a CDI apparatus is currently utilized in a variety of fields, removal of one of cations and anions may often be sufficient and development of a CDI apparatus suitable for functions thereof is required. For example, water used to wash laundry may be provided in an amount required for washing laundry by removing only cations, thus eliminating the necessity of designing a CDI apparatus to remove anions.

### SUMMARY

Therefore, it is an aspect of the embodiments to provide a deionization apparatus wherein only one electrode module of a pair of electrode modules to which a power is applied has a capability to remove either cations or anions contained in a liquid, to remove only one of cations and anions, to improve production efficiency and to reduce manufacturing costs.

It is another aspect of the embodiments to provide an electrode module wherein, for an electrode module with a deionization capability, a carbon nanomaterial is directly grown on the collector surface to form an electrode and a protective film is used to improve the strength of the collector, thereby minimizing contact resistance between the carbon nanomaterial and the collector and improving structural strength, and a method for manufacturing the electrode module.

Additional aspects and/or advantages of the invention will be set forth in part in the description which follows and, in part, will be apparent from the description, or may be learned by practice of the invention.

In accordance with one aspect of the embodiments, there is provided a deionization apparatus including: a first electrode module to which positive or negative power is applied; and a second electrode module to which a power of opposite polarity to the power applied to the first electrode module or a ground potential is applied, wherein only the first electrode module includes an ion-adsorption material to adsorb only one of cations and anions.

In accordance with another aspect of the embodiments, there is provided a deionization apparatus including: a pair of end plate units; and a plurality of unit electrode modules stacked between the end plate units; wherein the unit electrode module includes a first electrode module to which a positive (+) or negative (−) power is applied, and a second electrode module, containing no ion-adsorption material, to which a power of opposite polarity to the power applied to the first electrode module or a ground potential is applied, wherein only the first electrode module has an ion-adsorption material to adsorb only one of cations and anions.

The first electrode module may have an integral structure including a collector containing an ion-adsorption material, a protective film thermally compressed on the edge of the collector, and an insulating plate to isolate the ion-adsorption material.

In accordance with another aspect of the embodiments, there is provided a method for manufacturing an electrode module used for removal of ions from a deionization apparatus, the method including: growing a carbon nanomaterial on the surface of a collector; thermally compressing a protective film on the edge of the collector; and adhering an insulating plate to the protective film to isolate the carbon nanomaterial.

In accordance with another aspect of the embodiments, there is provided an electrode module for a deionization apparatus, including: either a wire electrode or a thin film electrode; and a spacer plate having a predetermined space to accept the electrode.

In accordance with the embodiments, among a pair of electrode modules to which a power is applied, only one electrode module includes an electrode capable of adsorbing ions to impart an ion-adsorption capability thereto and the other electrode module includes an electrode having no ion-adsorption capability so as not to impart an ion-adsorption capability thereto, to remove only one of cations and anions, improve production efficiency and reduce manufacture costs.

In accordance with the embodiments, a carbon nanomaterial is directly grown over the entire surface of the collector of the electrode module with a deionization capability by chemical vapor deposition (CVD) to form an electrode, thereby minimizing contact resistance between the carbon nanomaterial and the collector.

In accordance with the embodiments, when a carbon nanomaterial is directly grown over the entire surface of the collector of the electrode module with a deionization capability by CVD to form an electrode, the carbon nanomaterial is arranged in one direction to unify the orientation of the carbon nanomaterial and thus to improve the adsorption capability of ions.

In accordance with the embodiments, a protective film is coated over the collector of the electrode module with a deionization capability to reinforce the strength of the collector and efficiently prevent corrosion and damage thereof.

In accordance with the embodiments, the electrode module with a deionization capability is provided with an ion-exchange film through which cations or anions pass, to prevent opposite-charge ions from being injected and then adsorbed, while detaching the adsorbed ions from the electrode.

In accordance with the embodiments, the electrode of an electrode module having no deionization capability is formed in a wire or thin film shape, thereby reducing manufacturing costs, improving production efficiency, and decreasing an internal hydraulic pressure of the electrode module due to a widened liquid channel.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view illustrating a deionization apparatus according to one embodiment;

FIG. 2 is a partial enlarged view illustrating the section “A” of the deionization apparatus shown in FIG. 1;

FIG. 3 is a view illustrating the structure of a deionization apparatus wherein a negative power is applied to the first electrode module and a ground potential is applied to the second electrode module;

FIG. 4 is a partial perspective view of the first electrode module included in the deionization apparatus according to the one embodiment;

FIG. 5 is a flowchart illustrating a method for manufacturing the first electrode module;

FIG. 6 is a view illustrating arrangement of the carbon nanomaterial in the first electrode module included in the deionization apparatus according to one embodiment;

FIG. 7 is a view illustrating a first electrode module included in the deionization apparatus according to another embodiment;

FIG. 8 is an exploded perspective view illustrating a second electrode module included in the deionization apparatus according to one embodiment; and

FIG. 9 is an exploded perspective view illustrating a second electrode module included in the deionization apparatus according to another embodiment.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below by referring to the figures.

According to one embodiment, the deionization apparatus is designed such that only one of a pair of electrode modules is capable of removing ions contained in a fluid, thereby removing either cations or anions contained in a fluid. Hereinafter, a deionization apparatus capable of removing cations contained in water will be illustrated for a better understanding.

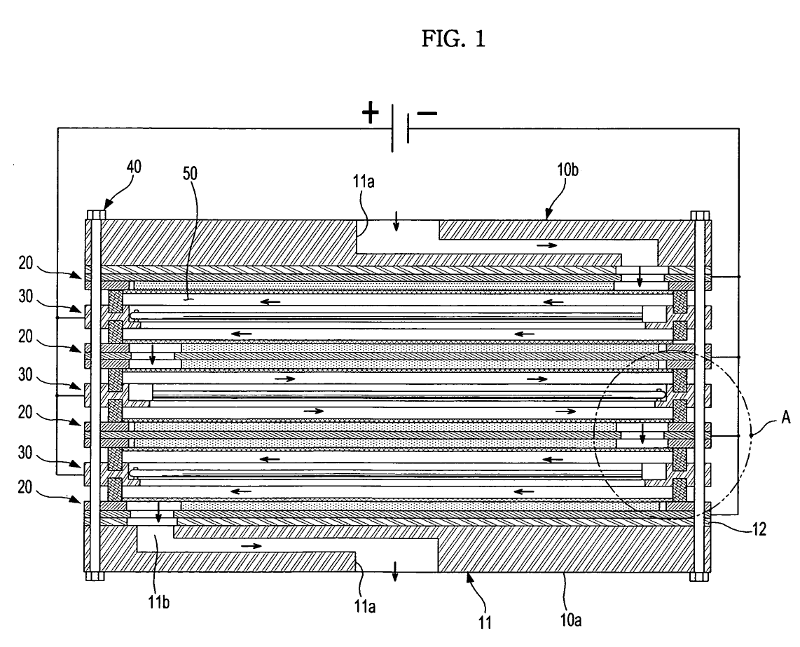

FIG. 1 is a sectional view illustrating a deionization apparatus according to one embodiment.

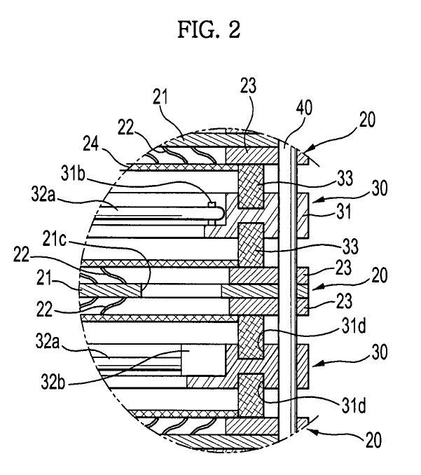

FIG. 2 is an enlarged view illustrating the section “A” of the deionization apparatus shown in FIG. 1.

As shown in FIGS. 1 and 2, the capacitive deionization apparatus (hereinafter, referred to as a “CDI apparatus”) according to one embodiment aims to electrochemically remove ions in a liquid, which includes: a pair of end plate units 10a and 10b which constitute the top and bottom of the CDI apparatus, respectively, each being provided with an inlet 11a; a plurality of unit electrode modules 20 and 30 stacked between the end plate units 10a and 10b such that they are spaced apart from one another by a predetermined distance; and a combination member 40 to join the pair of end plate units 10a and 10b to the unit electrode modules 20 and 30.

Accordingly, when among the unit electrode modules 20 and 30, a negative power is applied to a first electrode module 20a and a negative power is applied to a second electrode module 30, water is introduced to the inlet of the top and the bottom, cations contained in the water are adsorbed on an ion adsorption material of the electrode module, while the water moves in a zigzag form along an arrow direction through the channel formed in the electrode modules 20 and 30 and passes through the negative power-applied electrode module.

As such, the CDI apparatus has a stack structure wherein a plurality of electrode modules 20 and 30 alternate on one end plate unit 10a, the other end plate unit 10b is stacked thereon and the space provided between the adjacent electrode modules 20 and 30 corresponds to unit cells 50 where ions are adsorbed.

The end plate units 10a and 10b include a first end plate unit 10a to form the bottom appearance of the CDI apparatus and a second end plate unit 10b to form the top appearance thereof.

The first and second end plate units 10a and 10b are provided with the same structure. Accordingly, a detailed explanation of only the first end plate unit 10a will be given below. The first end plate unit 10a includes an end plate unit 11 and an end spacer 12 arranged thereon. An outlet 11a, through which water is supplied and discharged, is formed on one side of the end plate unit 11 and is connected to a water supply line arranged outside, and a channel 11b, through which water is supplied to the CDI apparatus and discharged therefrom, is formed on the other side thereof. In addition, the end plate unit 11 may be variably selected from metals, plastics and rubbers. A plastic material is preferred.

The unit electrode modules 20 and 30 include a first electrode module 20 to which a negative (−) power is applied, and a second electrode module 30 to which a positive (+) power is applied.

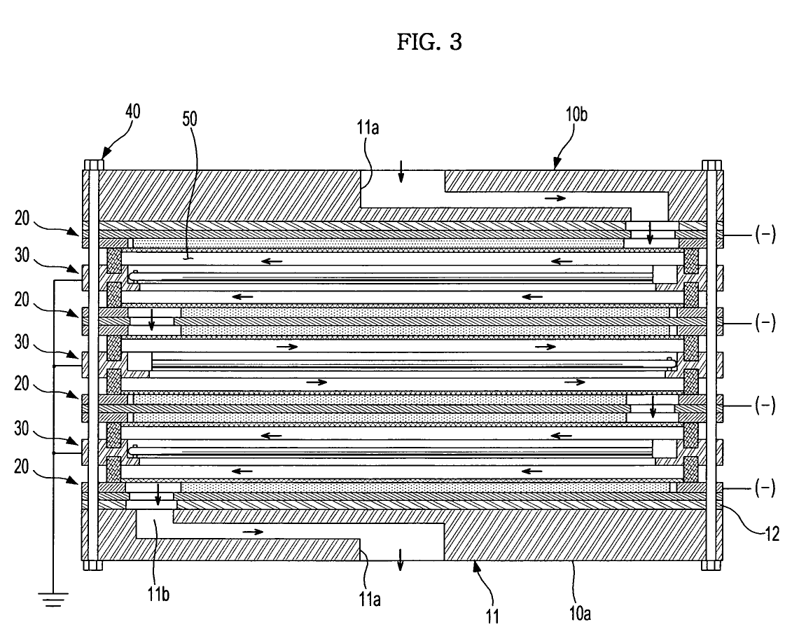

For the deionization apparatus according to one embodiment, as when a negative power is applied to the first electrode module 20 and a positive power is applied to the second electrode module 30, the oppositely charged power may be applied to the first electrode module 20 and the second electrode module 30, but the embodiment is not limited thereto. As shown in FIG. 3, the deionization apparatus may have a structure wherein a negative power is applied to the first electrode module 20 and a ground potential is applied to the second electrode module 30 by grounding the second electrode module 30 to the first electrode module 20.

Although mentioned below, the first electrode module 20 has an ion-adsorbing material, thus exhibiting an ion-deionization capability, while the second electrode module 30 has no ion-adsorbing material, thus exhibiting no ion-deionization capability.

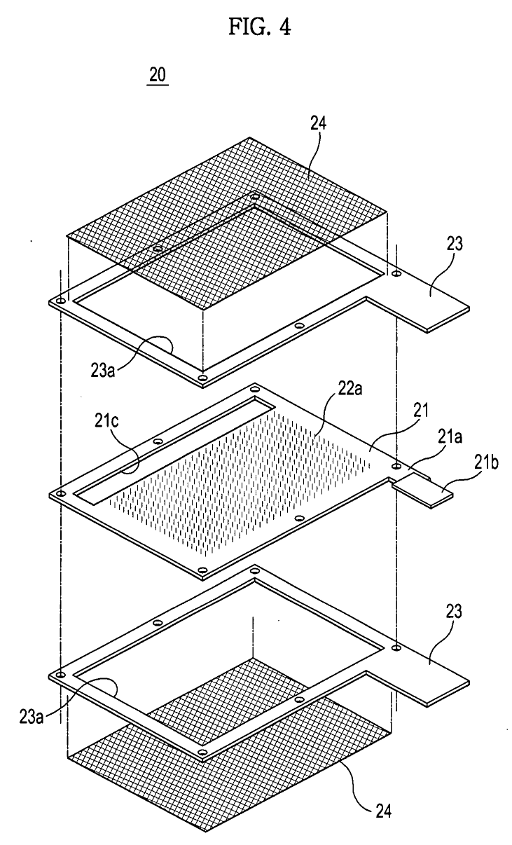

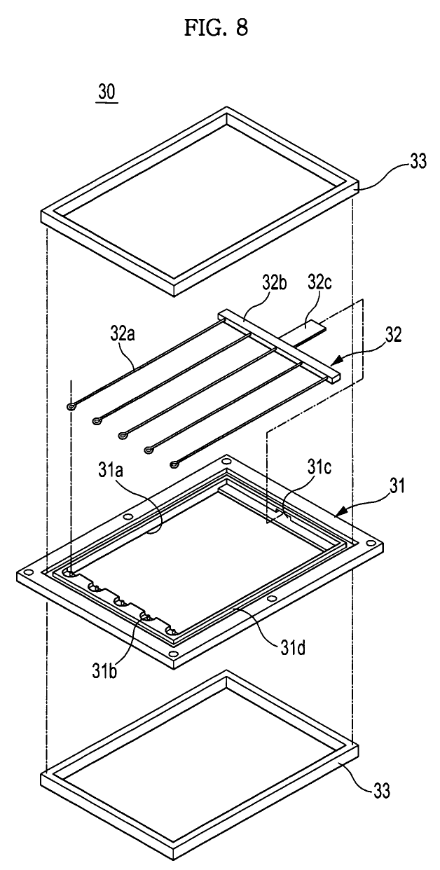

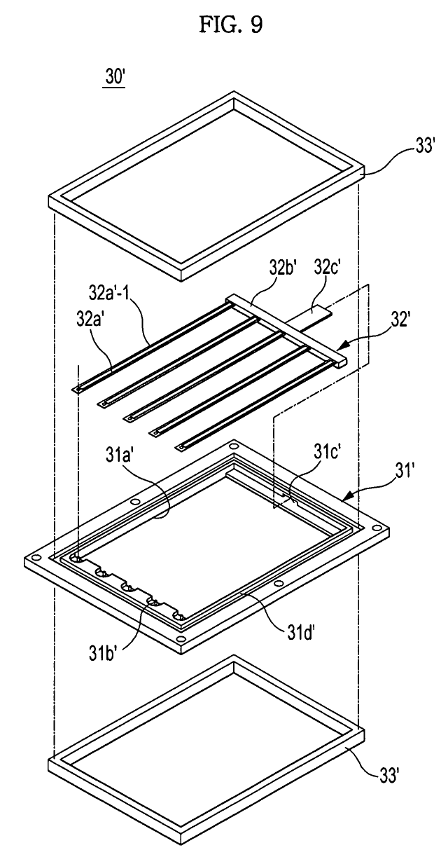

The embodiment of the first electrode module 20 is shown in FIGS. 4 to 7, and the embodiment of the second electrode module 30 is shown in FIGS. 8 and 9.

The first electrode module 20 may have an ion-adsorption material on either only the one side (the top or bottom) of the collector or on the both sides (the top and bottom) thereof.

Hereinafter, the first electrode module wherein an ion-adsorption material is present on the both sides of the collector will be illustrated below.

FIG. 4 is a partial perspective view of the first electrode module included in the deionization apparatus according to the one embodiment.

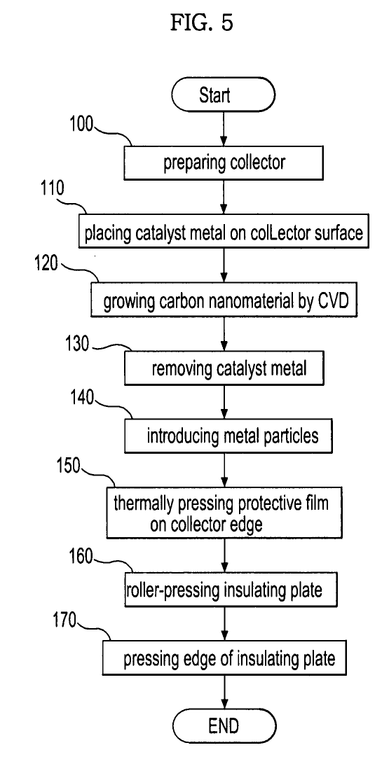

As shown in FIG. 4, the first electrode module 20 included in the deionization apparatus according to one embodiment includes a collector 21 where a negative (−) power is applied from the outside and a carbon nanomaterial 22a as a porous ion-adsorption material is directly grown on the surface thereof, a pair of protective films 23 adhered to the edge of the collector 21, and an insulating plate 24 bound to the protective films 23. In the construction of the present embodiment, the pair of protective films adhered to the collector and the insulating plate may also be applied to the case where a different ion-adsorption material is used, or an ion-adsorption material is separately provided and adsorbed on the collector (See FIG. 5 illustrated below).

The collector 21 includes a power connection 21a, which extends from the body for connection to the external power which extends from the body, and a terminal metal sheet 21b connected to the power connection 21a. The collector 21 receives an external power through the terminal metal sheet 21b connected to the power connection 21a. The collector 21 is provided at one side thereof with a channel 21c, allowing water to pass through a next cell 50. The size and shape of the channel 21c may be varied. The collector 21 may be composed of a material that has a low resistance and endures high temperatures. Representative examples of the collector material include metals such as titanium (Ti), nickel (Ni) and stainless steel, and graphite foil. In the present embodiment, graphite foil, which is anticorrosive and realizes manufacture cost savings, is used as an exemplary collector material.

The carbon nanomaterial 22a has a great deal of pores and exhibits superior adsorption capability. The carbon nanomaterial 22a may be activated carbon, a carbon nanotube, or a carbon nanofiber. In particular, the carbon nanomaterial may be directly grown on the surface of the collector 21 by chemical vapor deposition. A method for directly growing the carbon nanomaterial on the collector 21 will be illustrated below. In addition to the carbon nanomaterial 22a, the ion adsorption material may be nano-scale metal oxide. The metal oxide may be ruthenium oxide (RuO2), iridium oxide (IrO2), nickel oxide (NiO), etc.

The metal oxide may be directly formed on the collector by a sputtering method, in a way similar to the carbon nanomaterial directly formed on the surface of the collector by CVD.

The protective film 23 is provided with a hole 23a having a shape and size sufficient to cover the area of the carbon nanomaterial 22a. The protective film 23 is connected to the collector 21 while exposing the carbon nanomaterial 22a by passing the carbon nanomaterial 22a through the hole 23a. The protective film 23 is thermally pressed on the edge of the collector 21. Accordingly, by thermally pressing the protective film 23 onto the collector 21, structural strength is imparted to the collector 21, and damage to the collector 21 can thus be prevented. That is, since the material for the collector 21, i.e., graphite foil, is disadvantageously easily torn due to low strength in spite of several advantages, the edge of the graphite foil may be coated with the protective film 23 to prevent damage to the graphite foil. The protective film 23 may be a polyimide film.

The insulating plate 24 is currently referred to as a separator, and is in the form of a mesh to insulate the carbon nanomaterial 22a and allows water to flow in the carbon nanomaterial 22a. The insulating plate 24 is connected to the protective film 23, such that it covers the carbon nanomaterial 22a to insulate the electrode module 30 from the carbon nanomaterial 22 adjacent thereto.

FIG. 5 illustrates a method for manufacturing the first electrode module.

Referring to FIG. 5, a predetermined size of the collector 21 is provided (100). A material for the collector is graphite foil.

After providing the collector 21, to directly grow a carbon nanomaterial 22a on the collector surface, catalyst metal particles are placed on both surfaces of the collector 21 (110). A method for placing catalyst metal particles on the graphite foil surface includes sputtering or spray drying.

After placing the catalyst metal on the collector 21, a carbon nanomaterial 22 is directly grown on the collector surface by CVD (120). For example, the collector surface containing a catalyst metal such as a metal salt or an aluminum salt is thermally treated at 600° C. to 1,200° C., reduced and then comes in contact with a mixture of hydrogen and a carbon-containing gas at 400° C. to 1200° C. over a predetermined time to deposit the carbon nanomaterial 22a on the collector 21.

After directly growing the carbon nanomaterial 22a, the catalyst metal is removed (130). In this process, the catalyst metal is removed by cleaning the collector surface with a chemical cleaning material.

After removal of the catalyst metal, metal particles are introduced into the carbon nanomaterial 22a (140). The metal particles have a sterilizing activity, thus preventing bacterial proliferation in water which is in contact with the carbon nanomaterial 22a.

After introducing metal particles in the carbon nanomaterial 22a, a protective film 23 is thermally pressed on the edge of the collector 21 (150). As illustrated above, because the material for the collector 21, that is, graphite foil, is readily torn, the edge of the collector 21 is coated with the protective film 23 to prevent damage to the graphite foil. The power connection 21a of the collector 21 is connected to the terminal metal sheet 21b and a protective film 23 is coated thereon.

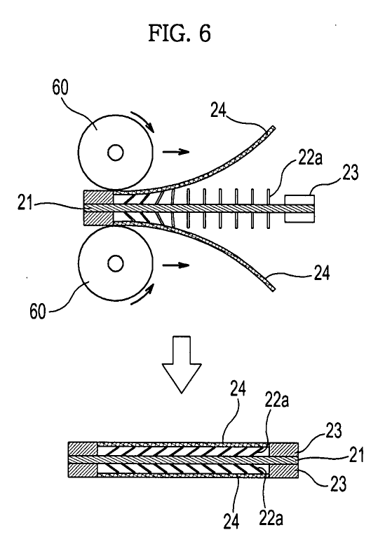

After thermally pressing the protective film 23 on the edge of the collector 21, an insulating plate 24 is roller-pressed on the protective film 23 and the carbon nanomaterial 22a (160). As shown in FIG. 6, the insulating plate 24 is pressed using a pair of rollers 60. To improve adsorption capability of the carbon nanomaterial 22a, the insulating plate 24 is rolling-pressed such that the carbon nanomaterial 22a is oriented in one direction.

After roll-pressing the insulating plate 24, the edge of the insulating plate 24 is pressed (170). In this process, the edge of the insulating plate 24 is further pressed using a jig for close contact with the protective film 23.

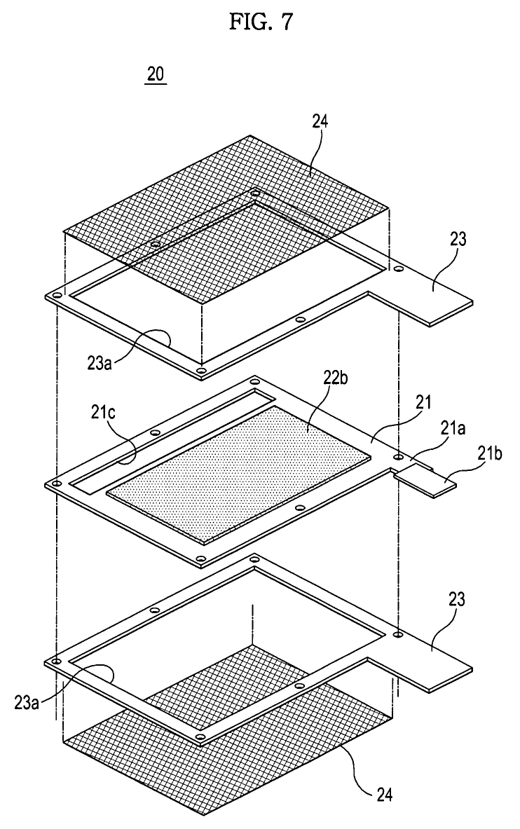

FIG. 7 illustrates another embodiment of the first electrode module 20 shown in FIG. 4, which is a partial perspective view of the first electrode module 20 wherein an ion-adsorption material is adhered to the collector by a conductive material.

As shown in FIG. 7, the electrode 21 in the first electrode module 20 is in the form of an ion-adsorption material 22b physically or chemically adhered to the collector 21. In this case, as compared to the electrode wherein the ion-adsorption material is directly grown on the collector, the contact resistance between the ion-adsorption material and the collector is relatively large, thus causing slight decrease in electrical conductivity.

Meanwhile, the second electrode module 30 has no necessity of ion-adsorption capability, and may thus take the form of, for example, a metal plate to which no carbon nanomaterial is adhered. However, when the collector or metal plate where only the ion-adsorption material is omitted from a conventional electrode structure, problems such as unnecessary waste of the electrode material and an increase in internal hydraulic pressure of the stack due to narrow channel and thus narrow flow passage may occur. Accordingly, to solve these problems, in the embodiment of the present invention, the second electrode module 30 is formed as a positive (+) electrode in a wire or thin film form, thereby reducing electrode material costs due to the possibility of variably changing the electrode shape, instead of the plate shape, and largely decreasing an internal hydraulic pressure of the stack due to widened channel area derived from the wire/thin film electrode.

FIG. 8 is a partial perspective view illustrating the second electrode module included in the deionization apparatus according to one embodiment of the present invention. The second electrode module includes a wire form of electrode.

As shown in FIG. 8, the second electrode module 30 included in the deionization apparatus according to one embodiment includes an electrode portion 32 with no ion-adsorption material and a spacer plate 31 to support the electrode portion 32 such that the second electrode module 30 is spaced apart from the first electrode module 20 by a predetermined distance. In addition, the second electrode module 30 may include a sealing material 33 to prevent water from leaking to the circumference of the spacer plate 31, provided in the both ends of the spacer plate 31. The spacer plate 31 includes a sealing groove 31d to accept the sealing material 33.

The electrode portion 32 includes a plurality of wire electrodes 32a connected to a terminal 32b and receives a power through a connection terminal 32c connected to the terminal 32b.

The spacer plate 31 includes a through hole 31a having a rectangular shape on which the electrode portion 32 is mounted. In addition, the spacer plate 31 further includes a protrusion 31b to fix one side of the wire electrode 32a of the electrode portion 32 at the internal circumference surface thereof, and a connection groove 31a through which a portion of the connection terminal 32c passes and which is exposed to the outside, at the opposite internal circumference surface thereof. The spacer plate 31 includes a sealing groove 31d in the top and bottom thereof to fix the sealing material 33 thereon.

Accordingly, the wire electrode 32a of the electrode portion 32 is connected to the protrusion 31b formed in the spacer plate 31, and the connection terminal 32c is inserted into the connection hole 31c of the spacer plate 31 to set the electrode portion 32 in the spacer plate 31. The sealing material 33 is fixed in the sealing groove 31d of the spacer plate 31.

FIG. 9 illustrates another embodiment of the second electrode module shown in FIG. 8, which illustrates the second electrode module including a thin-film electrode.

As shown in FIG. 9, the second electrode module 30′ has the same structure as the second electrode module 30 shown in FIG. 6, except for an electrode portion 32′.

The electrode portion 32′ includes a plurality of electrodes having a thin film shape. A protective film 32a′−1 to prevent the electrode 32a′ from bending or sagging, and thus improving strength, is adhered onto one side of the electrode 32a′.

As apparent from the foregoing, in the deionization apparatus according to one embodiment, the electrode of an electrode module having no deionization capability is formed in a wire or thin film shape, thereby reducing electrode material costs due to the possibility of variably changing the electrode shape, instead of the plate shape, improving production efficiency, and decreasing an internal hydraulic pressure of the second electrode module due to a widened water channel derived from the variation of the electrode shape.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A deionization apparatus comprising:
a first electrode module to which a positive or negative power is applied; and
a second electrode module to which power of opposite polarity to the power applied to the first electrode module or a ground potential is applied,
wherein only the first electrode module comprises an ion-adsorption material to adsorb only one of cations and anions.

2. The deionization apparatus according to claim 1, wherein the first electrode module includes:
a collector to receive a negative (−) power from the outside and contain a carbon nanomaterial on the surface thereof;
a protective film thermally compressed onto the edge of the collector; and
an insulating plate to insulate the ion-adsorption material.

3. The deionization apparatus according to claim 1, wherein the ion-adsorption material included in the first electrode module is formed on the surface of the collector receiving a power, by chemical vapor deposition (CVD) or sputtering.

4. The deionization apparatus according to claim 1, wherein the ion-adsorption material included in the first electrode module is adhered to the surface of the collector receiving a power.

5. The deionization apparatus according to claim 1, wherein the ion-adsorption material is either a carbon nanomaterial or metal oxide.

6. The deionization apparatus according to claim 5, wherein the carbon nanomaterial is activated carbon, a carbon nanotube, or a carbon nanofiber.

7. The deionization apparatus according to claim 5, wherein the metal oxide is RuO₂, IrO₂ or NiO.

8. The deionization apparatus according to claim 1, wherein the second electrode module includes a wire electrode or a thin film electrode.

9. The deionization apparatus according to claim 8, wherein one surface of the thin film electrode is coated with a film to prevent the electrode from being bent.

10. The deionization apparatus according to claim 8, wherein the second electrode module includes a spacer plate to accept the wire or thin film electrode in a space provided therein and allow the second electrode module to be spaced apart from the first electrode module at a predetermined distance.

11. The deionization apparatus according to claim 10, wherein the spacer plate includes a protrusion to fix the one side of the electrode and a connection hole through which a connection terminal arranged at the other side of the electrode passes.

12. The deionization apparatus according to claim 10, wherein the spacer plate includes a sealing groove to accept a sealing material to prevent leakage of the liquid to the circumference surface.

13. A deionization apparatus comprising:
a pair of end plate units; and
a plurality of unit electrode modules stacked between the end plate units;
wherein the unit electrode modules include a first electrode module to which a positive (+) or negative (−) power is applied, and a second electrode module, containing no ion-adsorption material, to which a power charged opposite to the power applied to the first electrode module or a ground potential is applied, and
only the first electrode module has an ion-adsorption material to adsorb only one of cations and anions.

14. The deionization apparatus according to claim 13, wherein the first electrode module has an integral structure comprising:
a collector containing an ion-adsorption material;
a protective film thermally compressed on the edge of the collector; and
an insulating plate to isolate the ion-adsorption material.

15. The deionization apparatus according to claim 13, wherein the second electrode module includes a wire electrode or a thin film electrode, a spacer plate to support the electrode such that the second electrode module is spaced apart from the first electrode module at a predetermined distance, and a sealing groove to accept a sealing material to prevent water from leaking to the circumference of the spacer plate.

16. The deionization apparatus according to claim 15, wherein the thin film- type electrode is coated on one surface thereof with a film to prevent the electrode from being bent.

17. An electrode module to remove ions from a deionization apparatus, comprising:
a collector containing an ion-adsorption material;
a protective film thermally compressed on one edge of the collector; and
an insulating plate to isolate the ion-adsorption material.

18. The electrode module according to claim 17, wherein the ion-adsorption material is activated carbon, a carbon nanotube, or a carbon nanofiber, and
the carbon nanomaterial is directly formed on the collector by chemical vapor deposition (CVD).

19. The electrode module according to claim 17, wherein the insulating plate is adhered to the protective film such that the carbon nanomaterial is arranged in one direction.

20. A method for manufacturing an electrode module used for removal of ions from a deionization apparatus, the method comprising:
growing a carbon nanomaterial on the surface of a collector;
thermally compressing a protective film on the edge of the collector; and
adhering an insulating plate to the protective film to isolate the carbon nanomaterial.

21. The method according to claim 20, wherein the adhesion of the insulating plate to the protective film is carried out by pressing the insulating plate thereon with a roller such that the carbon nanomaterial is arranged in one direction.

22. An electrode module for a deionization apparatus, comprising:
either a wire electrode or a thin film electrode; and
a spacer plate having a predetermined space to accept the electrode.

23. The electrode module according to claim 22, wherein the spacer plate includes a protrusion to fix the one side of the electrode and a connection hole through which a connection terminal arranged at the other side of the electrode passes.

24. The electrode module according to claim 22, wherein the spacer plate includes a sealing groove to accept a sealing material to prevent leakage of the liquid to the circumference surface.
